(19) United States
(12) Patent Application Publication
(10) Pub. No.: US 2010/0238027 A1
(43) Pub. Date: Sep. 23, 2010

(54) DEVICE FOR MONITORING THE HEALTH STATUS OF STRUCTURES

(76) Inventor: Filippo Bastianini, Bologna (IT)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/740,599

(22) PCT Filed: Nov. 10, 2008
(86) PCT No.: PCT/IT08/00701

§ 371 Date: Apr. 29, 2010

(30) Foreign Application Priority Data
Nov. 16, 2007 (IT) BO2007A000756
Nov. 10, 2008 (IT) PCT/IT2008/000701

(51) Int. Cl. G08B 21/00; G06F 15/00; G06F 19/00

(52) U.S. Cl. 340/540; 702/188; 702/34

(57) ABSTRACT

Structural health monitoring device with improved reliability and performances that is applied in selected locations on a structure. The structural health monitoring device includes a data acquisition, process and storage media, a direct and independent wireless connection system to a standard and globally interconnected telecom network, is uninterruptedly powered by a power management system featuring at least two battery power sources. The structural health monitoring device further includes sensors specifically intended to remain permanently active and “asynchronously” trigger data acquisition sessions in occurrence of timely unpredictable phenomena having structural relevance and is moreover comprising data processing media for data compression and for automatic detection of possible structural anomalies using a self-training neural data processing algorithm.

### TECHNICAL FIELD OF THE INVENTION

The present invention relates to Structural Health Monitoring, a practice diffused in the industrial field related to the management of infrastructures, buildings and structures in general. Structural Health Monitoring is performed using sensors, sensor interrogation, data collection and data transmission equipments intended to record data related to structurally significant parameters over a certain period of time.

### PREVIOUS STATE OF THE ART

From U.S. Pat. No. 4,480,480 (Scott et al., 27 Apr. 1982) are known to the state of the art generic Structural Health Monitoring systems featuring a plurality of sensors that are installed on the structure under observation and that are wired to a central data collection unit capable of interrogating the sensors, recording the data and making them available locally.

Systems featuring specific sensing devices or methodologies are also known to the state of the art: U.S. Pat. No. 5,195,046 (Gerardi et al., 30 Jul. 1990) discloses a monitoring system featuring an active dynamic excitation sensing system, U.S. Pat. No. 6,012,337 (Hodge, filed 15 Jun. 1998) discloses a monitoring system featuring specific corrosion sensors, application PCT/IT2004/000024 (Sarchi et al., 30 Jan. 2004) discloses a monitoring system featuring a carbon fibre crack sensor, application PCT/GB2005/002784 (Stothers et al., 15 July 2005) discloses a monitoring system featuring acoustic emission sensors, and U.S. Pat. No. 6,647,161 (Hodge, filed 13 Nov. 2002) discloses a monitoring system featuring fibre optic cable connection between the sensor and the data collection unit.

Several other structural monitoring systems, that can be generically addressed as “wireless monitoring devices” are also known to the state of the art: U.S. Pat. No. 5,507,188 (Svaty Jr., 24 May 1995), patent JP2002357486 (Hisashi et al., 13 Dec. 2002) and application PCT/US03/09644 (Watters et al., 26 Mar. 2003) disclose monitoring systems featuring a sensor (a strain gauge in particular), a single power source, sensor interrogation and wireless communication electronics intended to send the collected data to a single specific data collection unit located in the neighbourhoods.

Other known U.S. Pat. No. 6,622,567 (Hamel et al., 7 Mar. 2001) and patent applications US 2005/0204825 (Kunerth et al., 17 Mar. 2004), US 2006/0170535 (Watters et al., 4 Jan. 2006), US 2007/0095160 (Georgeson et al, 3 Nov. 2005), US 2007/0186677 (Zunino et al., 14 Feb. 2007), PCT/US01/4686 (Srinivasan et al., 7 Dec. 2001) disclose “wireless monitoring devices” that focus on the possibility of powering the sensor device with a “transponder-like” system by drawing the necessary power from the electro-magnetic field produced by a specific “ad hoc” interrogation unit located in the immediate neighbourhoods of the sensor unit.

U.S. Pat. No. 6,192,759 (Schoess, 2 Feb. 1999) discloses a different type of “passive” “wireless network monitoring device” featuring a “power harvesting” unit intended to convert forms of stray energy environmentally present (typically mechanical vibrations) into a form of electrical energy suitable for operating the device electronics.

Moreover several “wireless monitoring device” intended for network operations, commonly addressed as “wireless sensor nodes” or “motes” are also commercially available from many companies such as “Crossbow technology, Inc.” (San Jose, Calif., USA), “Advanced Conversion Technology, Inc.” (Middletown, Pa., USA), “Millennial Net, Inc.” (Cambridge, Mass., USA), “Moteiv Corp.” (San Francisco, Calif., USA), “Microstrain, Inc.” (Williston, Vt., USA). Patent application WO 2006/120435 (Harker B., 11 May 2005) discloses a “wireless monitoring device” featuring a specific type of sensing (crack gauging) that integrates in the same unit the electronic parts intended to interrogate the crack gauge, record the data and radio-transmit them to a specific centralized data communication units that has to be located in the neighbourhoods and that acts as a gateway to transfer the data to a remote system connected to the Internet. Patent applications US 2007/0093945, US 2007/0093973, US 2007/0093974, US 2007/0093975 (Hoogenboom C. L., 20 Oct. 2005) focus on specific communication and handshaking protocols between the wireless sensor nodes and the centralized data communication unit.

Very few of the monitoring devices known to the state of the art specifically include data processing capabilities: patent application US 2004/0143398 (Nelson, 5 Jan. 2004) mentions the integration in the monitoring device of data processing capabilities specifically aimed to the spectral analysis of mechanical vibration, patent application PCT/US2004/038395 (Giorgiutiu & Xu, 12 Nov. 2004) claims a device featuring integrated media sensitive to structural anomalies, data processing capability and signal transmission capability. A deeper analysis of the description of the latter application shows that the technical innovation described focuses on the integration of a specific piezoelectric sensor characterized by an actively excited self-balancing bridge circuit with a vector impedance analyser whose function is to detect anomalies through changes in the acoustical impedance spectrum of the sensor element that has to be installed on the element under test.

Patent application US 2006/0069520 (Gorinevsky, 28 Sept. 2004) describes a methodology intended for detecting possible structural anomalies by comparing the actual value of a plurality of sensed structural parameter with a threshold value established in advance by averaging the value of the same parameters in a certain previous period of time.

U.S. Pat. No. 5,421,204 (Svaty Jr., 8 May 1993) claims a structural monitoring methodology exploited by analysing the frequency spectral content of the signal collected by a strain gauge sensor and comparing it to that of a known structural condition that is addressed as “baseline” condition.

Are known to the state of the art few methodologies of processing generic data using on neural networks: patent TW 440779B (Je-Shiung et al., 16 Jun. 2001) describes the use of neural data processing for analysing the dynamic behaviour of machine tools, patent KR 20050081630 (Chang Sung et al., 19 Ago. 2005) proposes a methodology aimed to evaluate structural damage through a neural network pattern comparison of dynamic vibration spectra. U.S. Pat. No. 5,774,376 (Manning, 7 Aug. 1995) claims a structural integrity monitoring system featuring an active vibration exciter, sensors and a trainable adaptive interpreter to evaluate the damage condition by analysing the dynamic response of the structure under test.

What is clear from the analysis of the previous state of the art is that:
a) known “wireless monitoring devices”, “wireless sensor nodes” or “motes” are intended to communicate with a specific “data collector-concentrator” unit located in the neighborhoods that, especially in case of network-organized systems, is typically addressed as the “supernode”, “gateway” or “coordinator” of the network. The “data collector-concentrator”, when it is not intended as the final storage place for the collected data, is the gateway of any communication over a standard and globally interconnected telecom network to the final data storage place, or to the remote recipient, or to the Internet.
b) Known “wireless monitoring devices”, “wireless sensor nodes” or “motes” are intended to be powered by a generic battery, or by parasitically drawing the required power from the electro-magnetic field radiated from an interrogator device, or from “stray” energy forms collected by specific “power harvesting” generators.
c) Very few of the known “wireless monitoring devices” integrate specific data processing capabilities intended to allow the device to autonomously identify possible anomalies of the structural behaviour. The only suggested damage detection methodologies are based on generic sensed value comparison against threshold values calculated by averaging “historical” data or on the generic evaluation of changes of the acoustical impedance or of the dynamic resonance of the structural element under test.
d) Known “wireless monitoring devices” do not specifically integrate any neural network data processing capability aimed to assess the occurrence of structural anomalies, especially by analysing the historical evolution of non-dynamic data.
e) Known “wireless monitoring devices” are intended to operate time-cyclic data acquisition sessions and do not integrate any system specifically engineered in order to remain permanently active and “asynchronously” trigger specific data acquisition session in occurrence of unexpected phenomena having structural relevance, such as seismic events, collisions, sudden landslides etc.
f) Known “wireless monitoring devices” pay marginal or no attention at all to the necessity of providing a housing of the device suitable to protect the system from the environmental agents such as dust, moisture, rain, corrosion etc. and from other actions such as shocks, vandalisms etc. None of the known systems specifically integrates as well any medium intended to detect tamper or vandalism. None of the known systems specifically integrates as well any medium intended to manually trigger special device operations, such as typically a manual control session, without violating the integrity or the water-tight sealing of the device housing.

### DISCLOSURE OF THE INVENTION

In a first broad independent aspect, the invention provides a structural monitoring device intended to be installed on a structure in a region where at least one structurally relevant physical parameter can be measured, and that is comprising: sensor(s) for the physical parameter(s) under observation, the electronics required for sensor interrogation and data acquisition and storage, housing media intended to accommodate and protect at least part of the system and a wireless communication unit capable to connect in a direct and independent way to a standard and globally interconnected telecom network, and a power management system featuring a plurality of power sources having at least two batteries, this power management system being intended to extend the “useful working life” of the device and to provide uninterruptible supply to the system even in the event of fault or discharge of one of the sources, and comprising at least one sensor specifically intended to remain permanently active and “asynchronously” trigger specific data acquisition session in occurrence of fast unexpected phenomena having structural relevance.

### Description of the Related Advantages

a) The capability of a direct and independent connection to a standard and globally interconnected telecom network allows the device to autonomously broadcast not only the collected data but also warning or maintenance messages, and is more advantageous than the “two step” long-range communication required by all known “wireless monitoring devices” that need a “data collector-concentrator” to act as a gateway to the telecom network. A direct and independent connection is advantageous because it is more reliable and makes easier, faster and cheaper to produce structural monitoring installations requiring a single sensor node. It also simplifies installations with sensor nodes placed very far the one from the other. Furthermore, in installations with more sensor nodes, a direct and independent connection of each sensor node to the telecom network increases the reliability of the whole system by providing redundancy.
b) Redundancy of the battery power source is very advantageous for increasing the reliability of the system, especially considering that the premature failure of batteries is one of the most common causes of “catastrophic failure” that leads to the irreversible loss of the sensor node. Considering that often the devices are installed in hardly accessible locations, the increased reliability and extended useful life is also advantageous in terms of savings on maintenance.
c) The presence of a permanently active sensor capable to asynchronously trigger data acquisition session is advantageous since it allows the electronic parts to be driven in a deep sleep condition between the cyclical time-driven data acquisition session, thus reducing the power consumption and extending the battery life, but at the same time it allows the device to remain fully responsive to any unexpected phenomena having structural relevance that could occur inside a “deep sleep” time window, such as seismic events, collisions, landslides etc.

In a first subsidiary aspect, the invention provides a structural monitoring device according to the first broad independent aspect and comprising data processing media intended to compress the collected data and intended to autonomously perform the detection of possible structural anomalies according to the following methodology: after having observed the typical behavior of the structure under test over a certain significant lapse of time, the data processing algorithm becomes trained to exploit the trends of the most recently acquired data into their time recurrent, converging and diverging components and uses the evaluated exploitations in order to perform direct and/or derivative threshold-based detection(s) of possible structural anomaly(es) and/or calculates a state-of-health estimation parameter through a polynomial and/or exponential combination of the evaluated exploitations.

### Description of the Related Advantages

a) The integration of data processing capabilities aimed to data compression is advantageous for increasing the local data storage capacity and for shrinking the amount of data that has to be broadcasted on the telecom network, thus reducing both the traffic-related costs and the power needed for communications, that is increasing the useful life of the batteries.
b) The integration of a data processing methodology aimed to autonomously perform the detection of possible structural anomalies is advantageous for the safety of the structure by granting at least a minimal warning system even in case the collected data get no further attention, for example due to transitory interruption of the final data uptake and processing services.
c) In particular the integration of a self-training data processing methodology aimed to recognize the typical behavior of the structure and to exploit its time recurrent, converging and diverging components provide the advantage of an increased sensitivity in detecting structural anomalies with improved early warning capabilities. In order to provide an example, that has not to be considered a limitation for any implication related to the present invention, a parameter such as the dilatation of a concrete structural member can be influenced by cyclical trends (such as the thermal expansion that has time-of-the-day and seasonal recurrences), converging trends (such as the asymptotical maturation of the concrete), and diverging trends (such as those related to the progression of the degradation of the reinforced concrete). An exploitation of the three individual contributions that build up the total apparent value of the dilatation helps detecting the effect of degradation phenomena at an earlier stage, at which, being the contribution due to degradation at the same order of magnitude of the other contributions, other known anomaly detection methodologies neglect it or produce false alarms.

In a second subsidiary aspect in accordance with the abovementioned first broad aspect or with the first subsidiary aspect, the invention provides a structural monitoring device wherein the said comprised wireless communication unit capable to connect in a direct and independent way to a standard and globally interconnected telecom network comprises at least one GSM cell-phone modem or GSM/GPRS cell-phone modem, or CDMA cell-phone modem, or UMTS cell-phone modem, or WiMAX cell-phone modem, or satellite modem. Considering that the cost of cell-phone modems has recently dropped to the same level of other short-distance wireless network modules, the only potential cost disadvantage of a direct and independent connection node to the telecom network of each single structural monitoring device has to be considered overcome thanks to this subsidiary aspect.

In a third subsidiary aspect in accordance with the abovementioned first broad aspect or with the first, or the second subsidiary aspect, the invention provides a structural monitoring device comprising at least one tamper sensor intended to trigger an alarm message broadcast operation in case of attacks to the device integrity or functionality. The present subsidiary aspect is advantageous in order to provide countermeasures and deterrent to events that could lead to the irreversible loss of the sensor node, such as vandalism.

In a fourth subsidiary aspect in accordance with the abovementioned first broad aspect or with the first, or the second, or the third subsidiary aspect, the invention provides a structural monitoring device comprising at least one sensor specifically intended to manually trigger special device operations, such as typically a manual control session, without violating the integrity or the water-tight sealing of the device housing. The present subsidiary aspect is advantageous in order to provide a fast, safe and easy way to test, configure and calibrate the system during its installation, without violating the integrity of its water tight housing and without having to wait the time-cyclic device self wake-up.

In a fifth subsidiary aspect in accordance with the first or second, or third, or fourth subsidiary aspect, the invention provides a structural monitoring device wherein the said comprised data processing media also evaluate the correlation and/or the cross correlation between at least some of the sensed parameters. The present subsidiary aspect is advantageous especially when the behavior of the parameter under test is also influenced by an environmental incidental parameter that can be independently measured with a different sensor (considering the abovementioned example of the dilatation, dilatation is also influenced by the incidental load on the structural member, load that can be evaluated for example with an additional load-cell sensor in order to purge the total measured dilatation from the “physiological” contribution due to the incidental load, thus increasing the sensitivity of the structural anomaly detection).

In a sixth subsidiary aspect in accordance with the with the first or second, or third, or fourth, or fifth subsidiary aspect, the invention provides a structural monitoring device wherein the said comprised wireless communication unit is capable to broadcast warning messages based on the results of the data processing methodology aimed to perform an automatic detection of possible structural anomalies. The present addition is advantageous to increase the reaction speed of the structure maintenance service to any anomaly, thus increasing the safety levels.

In a seventh subsidiary aspect in accordance in accordance with the with the first or second, or third, or fourth, or fifth, or sixth subsidiary aspect, the invention provides a structural monitoring device wherein the said data processing methodology is organized in form of a self-training neural data processing network capable to process non-dynamic data and, eventually, capable to process also dynamic data. The present addition better describes a preferred embodiment of the data processing algorithm that is advantageous for the processing speed.

### BRIEF DESCRIPTION OF DRAWINGS

A full and enabling disclosure of the present invention, including the best mode thereof, directed to one of ordinary skill in the art, is set forth in the specifications, which makes reference to the appended figures, in which:

FIG. 1 illustrates a preferred method of application of the object of the present invention to a structure and schematically illustrates the functional relationship of component modules within the device in accordance with the present technology and of the said device with the external environment.

FIG. 2 illustrates a schematic comparison between structural monitoring applications aimed at similar performances but carried out with known (prior art) methodologies and with a preferred method of application of the object of the present invention.

FIG. 3 illustrates a preferred mode of construction of the object of the present invention that is shown in an exploded view.

FIG. 4 illustrates preferred method of application of the object of the present invention for a geological site survey.

### DETAILED DESCRIPTION OF THE PREFERRED EMBODIMENTS

Selected combinations of aspects of the disclosed technology correspond to a plurality of different embodiments of the present invention. It should be noted that each of the exemplary embodiments presented and discussed herein should not insinuate limitations of the present subject matter. Features or steps described as part of one embodiment may be used in combination with aspects of another embodiment to yield yet further embodiments.

Additionally, certain features may be interchanged with similar devices of features not expressly mentioned which perform the same or similar function.

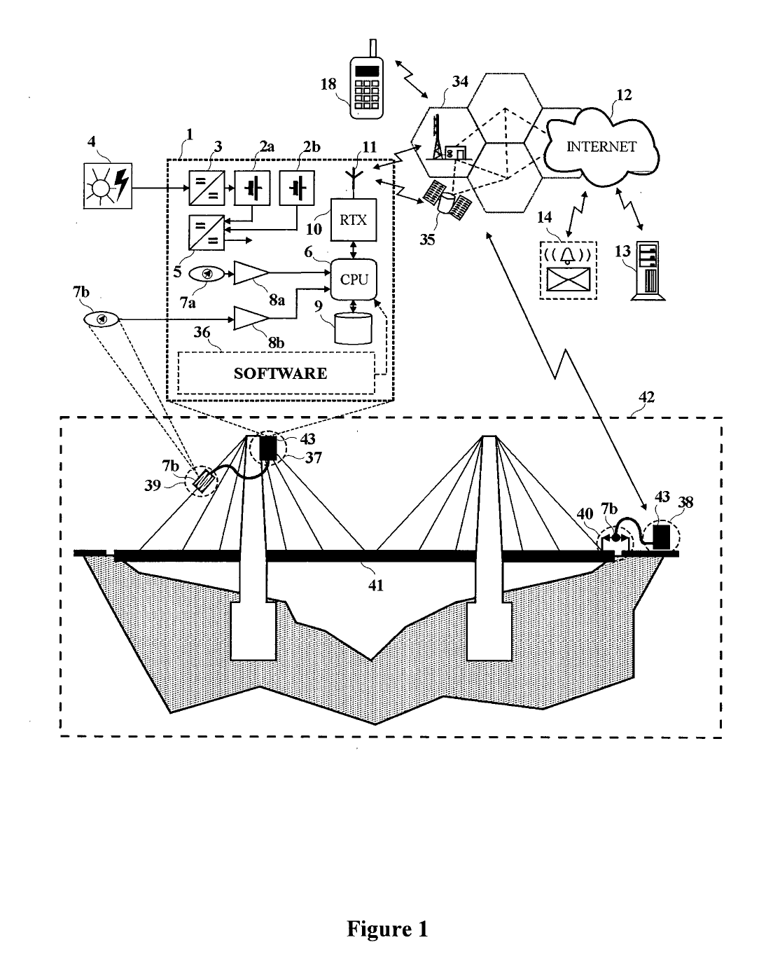

In FIG. 1 the dashed frame (42) illustrates a preferred method of application of the present invention where on a structure (41), shown as a cable-stayed bridge as an indicative example, have been selected one or more locations (37, 38) suitable for the installation of structural monitoring devices (43), in particular considering the fact that the said locations (37, 38) are in a region where at least one structurally relevant physical parameter can be measured and/or they are in the neighborhoods of specific structure points (39, 40) where at least one structurally relevant physical parameter could be measured by using a transducer (7b) specific for that parameter and that is connected to the closest structural monitoring device (43).

Furthermore, in FIG. 1, the dashed frame (1) schematically illustrates the housing of one of the structural monitoring devices (43) in accordance with the present invention and illustrates some of its component modules and their functional relationship. The device (43) comprises at least a sensor (7a) specifically intended to remain permanently active and “asynchronously” trigger specific data acquisition session in occurrence of unexpected phenomena of structural relevance. The device (43) also comprises one or more other internal (not shown) and/or external sensor (7b), electronic circuits devoted to sensor interrogation (8a, 8b), data acquisition (6) and data storage (9), a power management system (5) providing an uninterruptible supply and managing the available power sources in order to extend the battery life, a plurality of power sources featuring at least two batteries (2a, 2b). Even if not strictly necessary for the restrictions claimed by the present invention, an additional solar panel power source (4) is shown as well as its related power management system (3). The device in accordance with the present invention also comprises a wireless communication unit (10) capable to connect, in a direct and independent way, to a standard and globally interconnected telecom network (35 or 34) in order to broadcast, according to the algorithm embedded in the control software (36), messages and data to other telecom terminal(s) (18), to e-mail recipients (14) and to computer(s) (13) connected to the Internet (12).

Without insinuating limitations of the present subject matter the following details of the preferred embodiment are suggested:
the housing (1) should be a glass-fibre reinforced plastic encasing, water tight IP68 grade;
the sensor (7a) permanently active to “asynchronously” trigger specific data acquisition session should be a passive acceleration sensor typically comprising a portion of piezoelectric (or ferroelectric) material in a mechanical configuration electrically responsive to the inertial action of a test mass in presence of non-static acceleration or, as an alternative, a permanent magnet inertially confined so that its magnetic field concatenates at least partially with a pick-up coil.
the sensor(s) (7b) could be chosen into a wide range of transducer technologies suitable for measuring structurally relevant parameters such as displacement, inclination, stress, strain, force, torque, acceleration, corrosion, acoustic emission, ultrasonic time of flight, electrical impedance, temperature, moisture, presence of specific ions, etc. Suggested sensors technologies include LASER interferometry, LVDT gauges, potentiometric gauges, electrochemical cells, encoder gauges, MEMS sensors, resistive strain gauges, bridge sensors, piezoelectric sensors, temperature sensors, capacitive sensors, electro-dynamic sensors, magneto-dynamic sensors.
the sensor interrogation electronics (8a) should be chosen in accordance to the selected sensor transducer(s) (7a), considering the lower power consumption as preferential characteristic. In particular if a piezoelectric technology is chosen for the permanently active sensor (7a), the interrogation electronics should feature an op-amp high-impedance buffer front-end stage followed by a bandwidth limited filtering amplifier that feeds the input of a lower/upper threshold comparator pair.
the sensor interrogation electronics (8b) should be chosen in accordance to the chosen sensor transducer(s) (7b), considering the lower power consumption as preferential characteristic. Typical choices include digital interfaces, impedance bridge front-ends, impedance buffers and converters, filters, amplifiers, etc.
the data acquisition electronics should be chosen in order to match the system requirements and the performances granted by the chosen sensors and interrogating electronics. Typical choice can rely on the embedded peripherals of a microcontroller unit (6), suitably managed through a software (36) algorithm to use or emulate the required analog-to-digital conversion functions.
the power management system (5) should comprise a low quiescent power regulator intended to power the low consumption electronics, typically the microcontroller, and draining the supply from an automatic “or” logic between all the available power sources. Such “or” logic function should be obtained with active “ideal” diodes to minimize power waste. The power management system (5) should in addition comprise a boost, or a buck, or a buck-boost topology switching regulator to power the high consumption electronics when needed.
the power management system (5) drains the supply from at least two batteries (2a, 2b) according to the said uninterruptible system supply logic. The preferred system embodiment will feature three separate batteries comprising two Lithium primary (non-rechargeable) cells and (possibly) one auxiliary Lithium-polymer rechargeable cell that could be (possibly) recharged by a charge management controller (3) powered from the output of a solar panel (4) or wind turbine generator.
the wireless communication unit (10) is typically a cellular network modem compatible with one of the diffused cellular telecommunication standards, such as GSM, GPRS, UMTS, CDMA or a satellite modem if the device is intended to be installed in a geographical area with no or poor cellular network coverage. A GSM/GPRS cellular modem featuring embedded TCP/IP stack for direct internet connection should be typically preferred.
the device should also comprise an antenna (11) for wireless modem operation. Nevertheless the antenna (11) could be made as an interchangeable part and externally installed in order to optimize radio signal strength.

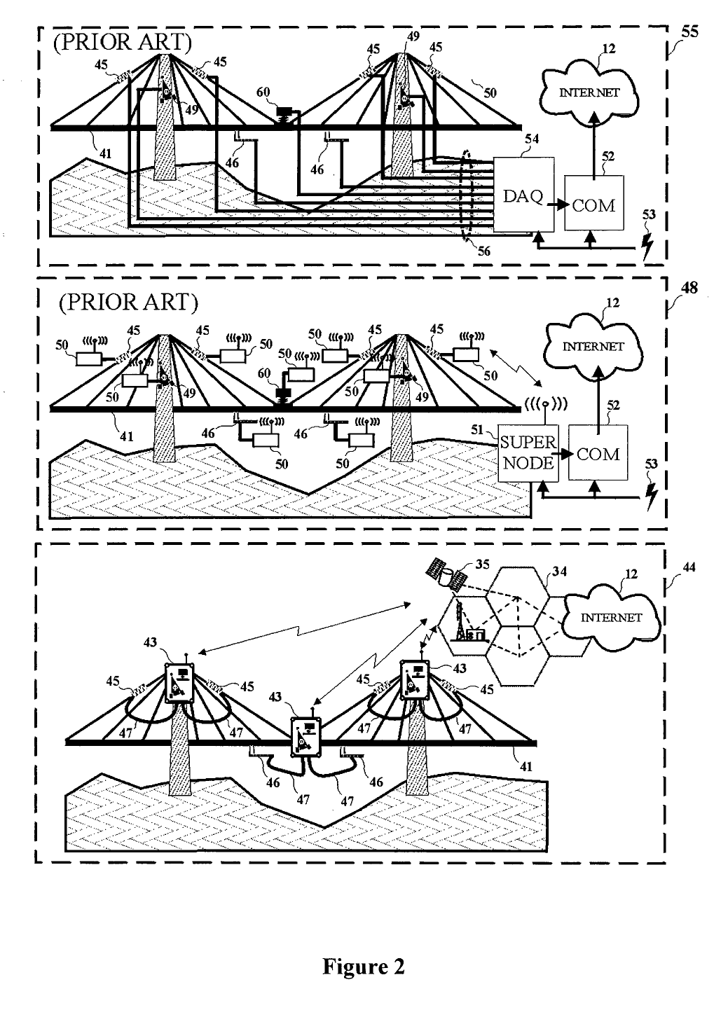

In FIG. 2 three different applications aimed to perform similar structural health monitoring functions are compared in order to better highlight some of the advantages of the present invention over the prior state of the art.

The upper frame (55) schematically illustrates a structural monitoring application carried out using traditional known wired sensors: strain gauges (45), inclinometers (49) displacement gauges (46) and accelerometer (60) are installed onto the structure (41) in specific points of interest and all sensor cables (56) are routed to a centralized data acquisition system (54) that, through an optional modem unit (52) is able to upload the collected data onto a wider network (12).

The mid frame (48) schematically illustrates a structural monitoring application carried out using “wireless monitoring devices” known to the state of the art. Each of the abovementioned sensors is connected to a separate “wireless sensor node” (50) device that interrogates it and downloads the collected data to a specific wireless “supernode” (51) of the network. Only the “supemode”, through an optional modem unit (52) is able to upload the collected data onto a wider network (12).

The lower frame (44) schematically illustrates a structural monitoring application carried out according to the present invention: few independent structural monitoring devices (43) placed in selected locations on the structure (41) collect data from the embedded sensors and, if required, from external wired (46) sensors installed in the neighborhoods (45, 46). Each monitoring device directly communicate with the final information recipients through the Internet (12) by directly connecting to a standard and globally interconnected telecom network (34 or 35).

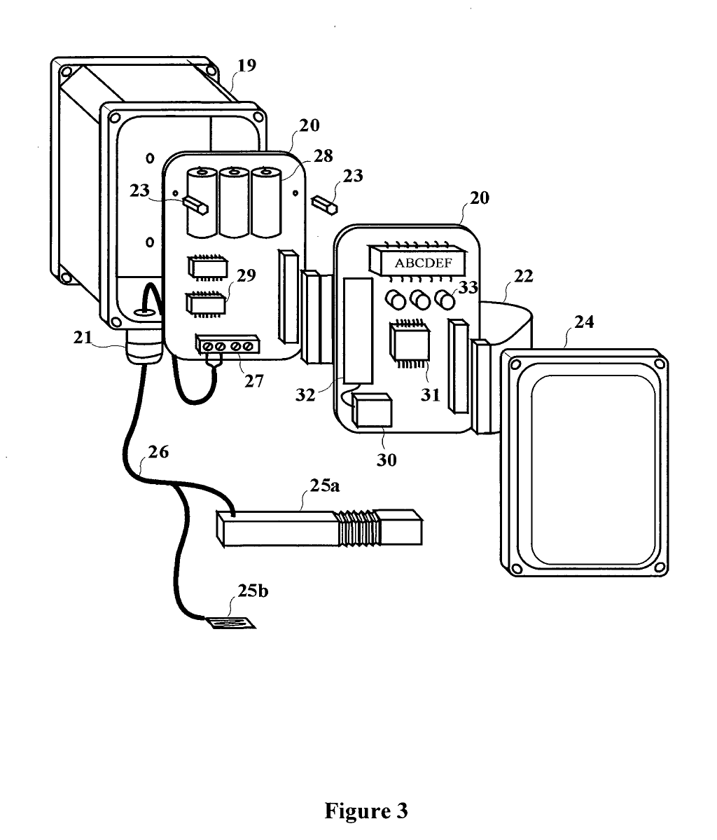

In FIG. 3 an exploded view of the preferred embodiment of the present invention is shown. A glass-fibre reinforced plastic encasing (19) houses the parts that most require protection against the environmental agents, shown under the aspect of two interconnected electronic printed circuit boards (PCBs). A first PCB (20) features the microcontroller and data storage electronic components (31), the wireless communication unit (30), a microstrip antenna (32), sensors and transducers (33), and is connected through a flat cable (22) to a second PCB (20) featuring the batteries (28), the sensor interrogation and power management electronics (29) and connection terminals for additional sensors (27). The two PCBs are mounted in a sandwich style with spacer columns (23). Possible external sensors, e.g. a strain gauge (25b) and a displacement gauge (25a), are connected by means of short wires (26) that penetrate the box through a water-tight sealed joint (21). A cover (24) of the same material of the encasing (19) seals the containment system providing an IP68 grade protection.

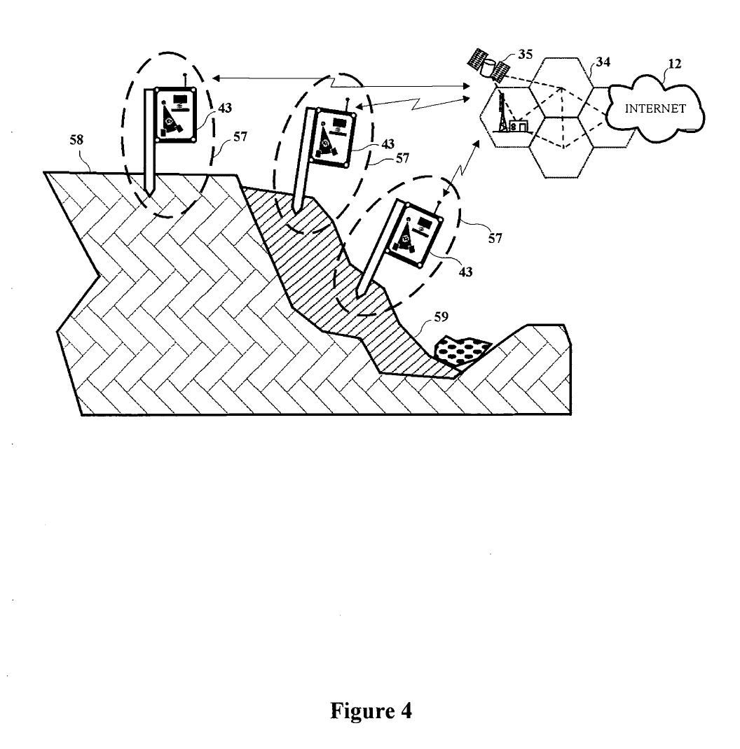

FIG. 4 shows an alternate preferred method of application of the present invention for a geological survey. In the illustration some independent monitoring devices (43) are shown as installed in selected locations (57) of a landslide-subject area. Each device collects data (in particular inclination data) useful to assess the settlement progression and uploads the information onto a wider network (12) by directly connecting to a standard and globally interconnected telecom network (34 or 35).

1-8. (canceled)

9. A structural monitoring device for being installed on a structure within or close to a region of it where at least one structurally relevant physical parameter can be measured, said monitoring device comprising:
at least one housing configured to accommodate and protect at least part of said structural monitoring device;
at least one sensor responsive to a physical parameter with direct or derived structural relevance;
at least one sensor interrogation system;
at least one data acquisition system;
at least one data storage system;
at least one microprocessor system;
at least one wireless communication system capable to connect, in a direct and independent way, to a standard and globally interconnected telecom network;
at least one power management system capable to provide at least one uninterruptible supply line;
a plurality of power sources comprising at least two batteries; and
at least one sensor specifically intended to remain permanently active and to trigger data acquisition sessions in occurrence of timely unpredictable phenomena having structural relevance.

10. The structural monitoring device according to claim 9 further comprising data processing media suitable to compress collected data, and autonomously detect structural anomalies according to a methodology.

11. The structural monitoring device according to claim 10, wherein said wireless communication system further comprising a modem selected from the group consisting of at least one GSM cellular modem, at least one GSM/GPRS cellular modem, at least one CDMA cellular modem, at least one UMTS cellular modem, at least one WiMAX cellular modem, and at least one satellite modem.

12. The structural monitoring device according to claim 11 further comprising at least one tamper sensor configured to trigger an alarm message broadcast operation in case of attacks to said structural monitoring device integrity or functionality.

13. The structural monitoring device according to claim 12 further comprising at least one sensor intended to manually trigger device operations without violating a water-tight seal of said housing.

14. The structural monitoring device according to claim 13, wherein said data processing media is configured to further evaluate a correlation and/or a cross correlation between for at least a part of the sensed parameters.

15. The structural monitoring device according to claim 14, wherein said wireless communication system is configured to broadcast warning messages based on results of said methodology aimed to perform an automatic detection of possible structural anomalies.

16. The structural monitoring device according to claim 15, wherein said methodology is organized in form of a self-training neural data processing network capable to process non-dynamic and dynamic data.

17. The structural monitoring device according to claim 9, wherein said sensor specifically intended to remain permanently active is a passive acceleration sensor.

18. The structural monitoring device according to claim 17, wherein said sensor responsive to a physical parameter is selected from the group consisting of transducers, LASER interferometry, LVDT gauges, potentiometric gauges, electrochemical cells, encoder gauges, MEMS sensors, resistive strain gauges, bridge sensors, piezoelectric sensors, temperature sensors, capacitive sensors, electro-dynamic sensors, and magneto-dynamic sensors.

19. The structural monitoring device according to claim 18, wherein said power management system comprising a low quiescent power regulator configured to power low consumption electronics and to drain a supply from an automatic “or” logic between said power sources, and further comprising a switching regulator to power high consumption electronics, said switching regulator being selected from the group consisting of a boost switching regulator, a buck switching regulator, and a buck-boost topology switching regulator.

20. The structural monitoring device according to claim 19, wherein said at least two batteries of said power sources are Lithium primary cells, and wherein said power sources further comprising at least one auxiliary Lithium-polymer rechargeable cell in electrical communication with a charge management controller powered from an output of a solar panel.

21. The structural monitoring device according to claim 9 further comprising a first electronic printed circuit board, and a second electronic printed circuit board in electrical communication with said first electronic printed circuit board, wherein said first electronic printed circuit board including at least a microcontroller, said data storage system, said wireless communication system, and a microstrip antenna, wherein said second electronic printed circuit board including at least said batteries, said sensor interrogation system, and said power management system.

22. The structural monitoring device according to claim 21, wherein said first and second electronic printed circuit boards being mounted in a sandwich style with spacer columns.

23. A method of monitoring a structure using a structural monitoring device, said method comprising the steps of:
a) installing a structural monitoring device on a structure within or close to a region of it where at least one structurally relevant physical parameter is measured;
b) triggering data acquisition sessions of at least one sensor specifically intended to remain permanently active, said data acquisition sessions are in occurrence of timely unpredictable phenomena having structural relevance;
c) acquiring date from at least one sensor attached to said structure, which is responsive to a physical parameter with direct or derived structural relevance using at least one data acquisition system;
d) storing said acquired data in at least one data storage system;
e) compressing said acquired data using a data processing media;
f) detecting autonomously structural anomalies using at least one microprocessor system;
g) observing typical behavior of said structure over a certain significant lapse of time;
h) exploiting trends of said acquired data into their time recurrent, converging and diverging components;
i) performing direct and/or derivative threshold-based detection of possible structural anomalies;
j) calculating a state-of-health estimation parameter through a polynomial and/or exponential combination of said exploited trends; and
k) connecting to a standard and globally interconnected telecom network using at least one wireless communication system.

24. The method according to claim 23 further comprising the step I) triggering an alarm message broadcast operation in case of attacks to said structural monitoring device integrity or functionality from at least one tamper sensor.

25. The structural monitoring device according to claim 24 further comprising the step m) triggering device operations manually without violating a water-tight seal of a housing said structural monitoring device.

26. The structural monitoring device according to claim 25 further comprising the step n) evaluating a correlation and/or a cross correlation between for at least a part of sensed parameters using said data processing media.

27. The structural monitoring device according to claim 26 further comprising the step o) broadcasting warning messages, using said wireless communication system, based on results of steps f)-j) aimed to perform an automatic detection of possible structural anomalies.

28. The structural monitoring device according to claim 27, wherein said steps f)-j) are organized in form of a self-training neural data processing network capable to process non-dynamic and dynamic data.
